(19) United States
(12) Patent Application Publication
(10) Pub. No.: US 2024/0283329 A1
(43) Pub. Date: Aug. 22, 2024

(54) ROTATING ELECTRICAL MACHINE

(71) Applicant: NIDEC PSA EMOTORS, CARRIERES SOUS POISSY (FR)

(72) Inventors: Juan WANG, VERNOUILLET (FR); Ioan DEAC, POISSY (FR); Radu FRATILA, ANTONY (FR); Jean Baptiste ROUX, VAUX SUR SEINE (FR); Hussain NOURI, NANTERRE (FR)

(21) Appl. No.: 18/572,065

(22) PCT Filed: Jul. 8, 2022
(86) PCT No.: PCT/FR2022/051371

§ 371 Date: Dec. 19, 2023

(30) Foreign Application Priority Data
Jul. 12, 2021 (FR) FR2107538

(51) Int. Cl. H02K 9/19

(52) U.S. Cl. CPC H02K 9/19

(57) ABSTRACT

Rotating electrical machine (1) extending along a longitudinal axis X, having a rotor (2) and a wound stator (3) having winding heads (30), the rotor (2) and the stator (3) being arranged in a casing (4) having an internal wall, the rotor (2) having at least one channel for distribution of a cooling fluid, the machine having at least one guide device (10) arranged radially between the winding heads of the stator and the internal wall of the casing, the guide device (10) being configured to orient the cooling fluid ejected from the rotor, particularly by centrifugal force, to the winding heads of the stator.

### CROSS-REFERENCE TO RELATED APPLICATIONS

This application is the US National Stage under 35 USC §371 of International Application No. PCT/FR2022/051371, filed Jul. 8, 2022, which claims the priority of French application 2107538 filed on Jul. 12, 2021, the content (text, drawings and claims) of both said applications being incorporated by reference herein.

### BACKGROUND

The present methods and devices relate to rotary electrical machines, and more particularly to those cooled by a circulation of a cooling fluid, in particular oil, circulating at least partially by the rotor of the machine.

More particularly, they relate to synchronous or asynchronous AC machines. In particular, they relate to traction or drive machines for electric motor vehicles (Battery Electric Vehicles) and/or hybrid motor vehicles (Hybrid Electric Vehicles-Plug-in Hybrid Electric Vehicles), such as private cars, vans, trucks or buses. The described methods and devices also apply to rotary electric machines for industrial and/or power generation applications, in particular naval, aerospace or wind turbine applications.

It is known to cool the winding heads of the stator during the operation of a rotary electrical machine by a cooling fluid coming from the casing.

Patent applications CN 211606273, EP 3 739731, JP 2019 161948, US 2011/0181136, JP 2018 014857, US 2011/0084561, JP2010028958, JP2020188633, and WO2021/069253 disclose electrical machines supplied with cooling fluid, comprising guide parts making it possible to orient the cooling fluid towards the winding heads. These applications do not disclose that the electrical machines can be supplied with cooling fluid from the rotor.

Application US 2011/0298316 discloses an agitation element arranged between the shaft of the rotor and the winding heads of the stator. This element makes it possible to cause the cooling fluid coming from the rotor to be raised to the winding heads. This arrangement makes the electrical machine complex to manufacture.

The application US 2019/0260257 discloses a protective element for three-phase busbars. Part of the cooling fluid coming from the casing and/or of the rotor can pass through the protective element and arrive at the winding of the winding heads of the stator by gravity. Such an element does not allow effective cooling of the winding heads of the stator.

When an electrical machine comprises a source of cooling fluid by the rotor, the fluid tends to move away from the rotor by the effect of centrifugal force. The cooling fluid then moves towards the internal wall of the casing and no longer participates in the cooling of the winding heads.

There is a need to further improve the cooling of rotary electrical machines cooled by a circulation of cooling fluid.

### SUMMARY

The described methods and devices aim to meet this need and it achieves it, according to one aspect, by virtue of a rotary electrical machine extending along a longitudinal axis X, having a rotor and a wound stator having winding heads,

the rotor and the stator being arranged in a casing having an internal wall,

the rotor having at least one channel for distribution of a cooling fluid, the machine having at least one guide device arranged radially between the winding heads of the stator and the internal wall of the casing,

the guide device being configured to orient the cooling fluid ejected from the rotor, particularly by centrifugal force, to the winding heads of the stator.

It is considered that “radially disposed between” relates to a radial position. Thus, the guide device is radially farther away from a shaft of the rotor than the winding heads and radially closer to the shaft than the internal wall of the casing.

Such a radial position of the guide device facilitates the assembly of the electrical machine. In addition, this position makes it possible to increase the quantity of cooling fluid that is redirected towards the winding heads.

The stator may comprise a stator mass.

On the other hand, the guide device may or may not be offset longitudinally with respect to the winding heads and/or relative to the internal wall of the casing. The guide device may be arranged longitudinally beyond the winding heads, for example it may be further away from the rotor mass than the winding heads. As a variant, the guide device may be arranged at least partially, or better still, completely above the winding heads.

The electrical machine may comprise two guide devices. Each guide device may be arranged at one axial end of the electrical machine. The two guide devices can be symmetrical to one another relative to a plane perpendicular to the longitudinal axis X of the electrical machine. Alternatively, the two guide devices can be asymmetrical with respect to one another relative to a plane perpendicular to the longitudinal axis X of the electrical machine.

As a variant, the electrical machine may comprise a single guide device.

The guide device may be in contact with the stator mass. As a variant, the guide device may be located at a non-zero distance d of the stator mass, measured on the longitudinal axis, the distance d being for example between 0 and 70 mm, better 2 and 60 mm, better 5 and 50 mm, better 10 and 45 mm, for example of the order of 15 mm or 40 mm.

The guide device makes it possible to break the jet of cooling fluid that is coming from the rotor to reorient it towards the winding heads. The guide device makes it possible to avoid the accumulation of cooling fluid near the casing. It makes it possible to improve the cooling of the machine by containing a larger quantity of cooling fluid close to the stator winding, in particular close to the slots, which are hot spots.

The guide device can be made of plastic material, for example it can be made of a polymer material, for example one of the following materials: polyamide, in particular nylon PA66GF30, polytetrafluoroethylene (PTLE), polyetheretherketone (PEEK), phenylene polysulfide (PPS), this list being not limiting.

The cooling fluid may be a liquid, for example water or oil. Alternatively, the cooling fluid may be a gas, for example air.

At least one axial channel for distributing the cooling fluid can be formed in the rotor mass, or along the shaft between the rotor mass and the shaft, or in the shaft. This or these axial distribution channels can pass axially through at least part of the rotor mass and/or the shaft. For example, this or these axial distribution channels can pass axially through the entire length of the rotor. Alternatively, they can pass through at least two-thirds of the length of the rotor, or at least half of the length of the rotor, or at least a third of the length of the rotor.

This or these axial channels can supply radial channels, for example radial channels located in the rotor mass or in end plates arranged at the ends of the rotor mass. The cooling fluid can be ejected from the rotor, in particular from the rotor mass or the end plates, towards the winding heads by the effect of centrifugal force.

The axial cooling fluid channel can be supplied with cooling fluid at least by the rotor.

The rotor may include permanent magnets inserted into the rotor mass. It may include permanent magnets, in particular surface or buried magnets. The rotor may be flux concentrated. It may comprise one or several layers of magnets arranged in I, U or V, in one or more rows. The housings of the permanent magnets can be made entirely by cutting into the laminations. Each lamination of the stack of laminations can be made of a single piece. The cooling fluid can also flow axially in the housings of the permanent magnets and join the end plates.

The electrical machine may further comprise a supply of cooling fluid through the casing, the cooling fluid coming from the casing being able to be oriented towards the winding heads, in particular by gravity, by the guide device.

The electrical machine can also be cooled by a cooling fluid that flows under gravity onto the winding heads from the casing.

The guide device then has a dual function. It not only makes it possible to channel the jet of cooling fluid coming from the rotor to reorient it towards the winding heads, but also allows the cooling fluid coming from the casing to flow towards the winding heads. The cooling of the electrical machine is thus improved. The guide device may be configured to promote the flow of the cooling fluid in one direction, for example the direction from the casing to the winding heads, and limit it in another, for example the direction from the rotor to the internal wall of the casing.

The guide device may be at least partially annular, in particular entirely annular, when seen in cross section, the guide device being able to be coaxial with a shaft of the rotor.

The guide device may have an angular extent around the longitudinal axis of the machine of at least 45°, or even at least 60°, better still at least 90°, better still at least 120°, better still at least 180°, better still at least 240°, for example 360°.

The guide device is easy to install on the electrical machine and does not complicate manufacturing of the machine.

The guide device may comprise an internal surface and an external surface and openings provided between the external surface and the internal surface and/or reliefs on the inner face.

The openings and/or the reliefs can make it possible to break the flow of cooling fluid and thus facilitate its reorientation towards the winding heads.

The reliefs may be ribs, in particular ribs extending parallel to the longitudinal axis X of the machine.

Alternatively, the reliefs may be ribs extending circumferentially with respect to the longitudinal axis X of the machine. Alternatively, the ribs may extend in a direction oblique to the axis of the longitudinal axis X of the machine.

The part of the internal surface of the guide device which comprises reliefs can extend over at least 20°, better still at least 30°, better still at least 45°, better still at least 60°, better still at least 90° around the longitudinal axis X of the machine. The part of the internal surface of the guide device which comprises reliefs can extend over at most 360°, better still at most 240°, better still at most 120°, better still at most 90°, better still at most 60° around the longitudinal axis X of the machine.

The openings can each extend along an elongation axis L which is oblique in a plane perpendicular to the longitudinal axis X of the machine.

The elongation axis L of the openings can be inclined relative to a plane containing the longitudinal axis X of the machine by an angle between −90 and +90°, better still between −60 and +60°, better still between −45 and +45°, better still between −30 and +30°.

Such an inclination of the openings makes it possible to limit the quantity of cooling fluid coming from the rotor that passes through the guide device and at the same time allows the cooling fluid coming from the casing to flow towards the winding heads.

In a plane containing the longitudinal axis X of the machine, the openings may extend along an axis parallel to the longitudinal axis X of the machine.

The elongation axes L of the openings may be oriented in the same oblique direction in a plane perpendicular to the longitudinal axis X of the machine.

At least half, better still at least two-thirds, in particular all the axes of elongation L of the openings can be oriented in the same oblique direction in a plane perpendicular to the longitudinal axis X of the machine.

At least half, better still at least two-thirds, in particular all the axes of elongation L of the openings can have the same inclination relative to a radial axis in a transverse plane of the machine.

In a variant, at least two openings may comprise axes of elongation L oriented in two different directions that are oblique in a plane perpendicular to the longitudinal axis X of the machine.

At least half of the openings may have elongation axes L1 of a first inclination relative to a radial axis in a transverse plane of the machine. The rest of the openings may have elongation axes L2 of a second inclination relative to a radial axis in this transverse plane of the machine. The first and second inclinations relative to a plane containing the longitudinal axis X of the machine may be different. They may in particular be opposite relative to a plane containing the longitudinal axis X of the machine.

Preferably, an opening having an elongation axis L1 of a first inclination is surrounded on either side by openings having an elongation axis L2 of a second inclination, different from the first inclination. There may therefore be an alternation of openings having axes of elongation of a first L1 and a second inclination L2 in the circumferential direction of the machine.

Two openings may be arranged in the form of a V or a truncated V. Two openings can be arranged in the form of a V with a half-angle at the apex of between 5° and 85°, better still between 30° and 60°, better still between 40° and 50°, for example of the order of 45°. At least half, better still at least two-thirds, in particular all the openings can be arranged in the form of a V with the same half-angle at the apex. The openings can be arranged in the form of a truncated V with half-angle at the apex of between 5° and 85°, better still between 30° and 60°, better still between 40° and 50°, for example of the order of 45°. At least half, better still at least two-thirds, in particular all the openings can be arranged in the form of a truncated V of the same half-angle at the apex. Preferably, the openings may alternatively be arranged in the form of a V and truncated V in the circumferential direction of the machine.

The fluid from the casing can flow through the openings by gravity. On the other hand, the majority of the cooling fluid coming from the rotor cannot rise through the openings. This particular orientation of the openings therefore makes it possible to facilitate the flow of the cooling fluid from the casing and to limit the flow of the cooling fluid from the rotor towards the internal wall of the casing.

The openings may have on the internal surface and/or on the external surface a surface area per opening of between 5 and 350 mm², better between 10 and 250 mm², better between 15 and 150 mm², for example, of the order of 20 mm².

The openings may have along the longitudinal axis X of the machine a length of between 2 and 50 mm, better still between 12 and 40 mm, for example of the order of 22 mm.

The distance between two adjacent openings on the inner and/or external surface of the guide device may be constant. The distance on the inner and/or external surface of the guide device between two openings having axes of elongation of the same inclination can be constant. The distance between the openings on the inner and/or external surface of the guide device may be variable.

The distance between two openings on the external surface of the guide device may be equal to the distance between two openings on the internal surface. Alternatively, the distance between two openings on the external surface of the guide device may be less than the distance between two openings on the internal surface. Alternatively, the distance between two openings on the external surface of the guide device may be greater than the distance between two openings on the internal surface.

Two adjacent openings on the external surface may be separated in a circumferential direction by no more than 100 mm, better still no more than 60 mm, better still no more than 30 mm, better still no more than 20 mm. Two adjacent openings on the external surface may be separated in a circumferential direction by at least 1 mm, better still at least 2 mm, better still at least 3 mm. For example two adjacent openings on the external surface may be separated in a circumferential direction by a distance of the order of 4 mm or 8 mm.

Two adjacent openings on the internal surface may be separated in a circumferential direction by at most 100 mm, better still at most 60 mm, better still at most 30 mm, better still at most 20 mm. Two adjacent openings on the internal surface may be separated in a circumferential direction by at least 0 mm, better still at least 1 mm, better still at least 2 mm, better still at least 3 mm. For example, two adjacent openings on the internal surface may be separated in a circumferential direction by a distance of the order of 0 or 4 mm. On the internal surface, two openings can join and form a single opening, in particular at the tip of the V formed by two adjacent openings having elongation axes of different inclination.

The total surface area of the guide device that comprises openings, without counting the surface area of the openings, may be between 0 and 46000 mm², better between 2000 and 33000 mm², better still between 4000 and 20,000 mm², better between 6000 and 15000 mm², better between 7000 and 10,000 mm², for example, of the order of 7700 mm² or 9000 mm².

The guide device may comprise a frustoconical part coaxial with the longitudinal axis X of the machine and oriented towards the winding heads.

The frustoconical part of the guide device can be arranged longitudinally beyond the winding heads when moving away from the stator mass. For example, the frustoconical part of the guide device can be arranged longitudinally to the left or right of the winding heads.

As a variant, the frustoconical part of the guide device can be arranged at least partially, better still completely, above the winding heads.

The frustoconical part of the guide device can flare when moving longitudinally away from the winding heads towards the outside of the machine.

As a variant, it can come closer to the longitudinal axis X of the machine when moving longitudinally away from the winding heads towards the outside of the machine.

The exterior surface of the frustoconical part may have an inclination of between 5 and 85°, better still between 10 and 60°, better still between 15 and 45°, for example of the order of 30° relative to the longitudinal axis X of the machine in a plane containing the longitudinal axis X of the machine.

The guide device may also comprise a horizontal wall. Openings can be made in the horizontal wall. In a particular embodiment, the guide device may comprise a horizontal wall and a frustoconical part.

The guide device may comprise at least one vertical wall extending from the internal wall of the casing to the winding heads. This vertical wall promotes the reorientation of the cooling fluid towards the winding heads.

The vertical wall can be in contact with the winding heads of the stator.

The height of the vertical wall in the radial direction may be greater or less than the gap between the winding heads and the internal wall of the casing. Alternatively, the height of the vertical wall in the radial direction may be equal to the gap between the winding heads and the internal wall of the casing.

The vertical wall can be arranged radially at a non-zero distance from the winding heads of the stator.

The radial space between the vertical wall and the winding heads facilitates the flow of the cooling fluid along the axis of elongation of the machine.

In another alternative embodiment, the guide device may comprise at least one wire mesh part. The wire mesh part may be flexible. As a variant, it can be rigid.

The wire mesh part may be arranged at a distance d from the winding heads of the stator. This distance d can be less than 10 mm, better still less than 5 mm, for example of the order of 4 mm. The wire mesh part may be located at a zero distance from the winding of the stator, that is to say be in contact with the winding of the stator. The fact that the wire mesh part is arranged at a small distance from the stator winding makes it possible to orient the cooling fluid by capillarity towards the winding heads. The wire mesh part makes it possible to attract the cooling fluid coming from the rotor and/or coming from the casing by capillarity.

The wire mesh part may have an inclination of between 0° and 45°, better still between 5° and 30°, better still between 5° and 20°, for example of the order of 10° relative to the longitudinal axis X of the machine in a plane containing the longitudinal axis X of the machine.

The wire mesh part may comprise a proximal end and a distal end. The proximal end is situated closer to the rotor mass than the distal end. The wire mesh part may approach the longitudinal axis X of the machine towards the distal end. Alternatively, the wire mesh part can diverge from the longitudinal axis X of the machine towards the distal end.

In an alternative embodiment, the guide device may comprise means for attachment to the casing. The guide device can thus act as a flange. The guide device can thus make it possible to ensure the mechanical retention and the attachment of the stator to the casing, and in addition to reorient the cooling fluid coming from the rotor towards the coil ends.

Alternatively or additionally, the machine may comprise, in addition to the guide device, a flange. The flange may be in contact with the guide device. Alternatively, the flange may be separated from the guide device.

The flange may comprise an internal surface and an external surface and openings provided between the external surface and the internal surface and/or reliefs on the inner face.

The flange may have a length along the longitudinal axis X of the machine of at least 2 mm, better still at least 3 mm, for example of the order of 4 mm. The flange may have a length along the longitudinal axis X of the machine of at most 10 mm, better still at most 5 mm, for example of the order of 4 mm. Such a length allows the flange to extend above the part of the winding that is close to the inlet of the slots. In the part of the winding close to the inlet of the slots, the electrical conductors may not include twisted portions. Therefore, the cooling fluid from the rotor more easily passes between the conductors. The presence of a flange at this axial position makes it possible to reorient this cooling fluid towards the winding of the coils and thus to improve the cooling of the machine.

The flange can be made of one of the following materials: aluminum, steel, stainless steel, plastic, this list being not limiting.

The machine may be used as a motor or as a generator. The machine may be a reluctance machine. It may be a synchronous motor or, alternatively, a synchronous generator. Alternatively still, it is an asynchronous machine.

The maximum rotational speed of the machine may be high, for example higher than 10,000 rpm, better still higher than 12,000 rpm, for example of the order of 14,000 rpm to 15,000 rpm, or even 20,000 rpm or 24,000 rpm or 25,000 rpm. The maximum rotational speed of the machine may be lower than 100,000 rpm, or lower than 60,000 rpm, or even lower than 40,000 rpm, better still lower than 30,000 rpm.

The described methods and devices may be most particularly suitable for high-power machines.

The machine may include a single inner rotor or, alternatively, an inner rotor and an outer rotor, which are arranged radially on either side of the stator and are rotationally coupled.

The machine may be placed into a casing on its own or inserted in a gearbox casing. In this case, it is placed in a casing that also houses a gearbox.

The slots may be at least partially closed. A partially closed slot makes it possible to provide an opening at the air gap, which can be used for example to install the electrical conductors for filling the slot. A partially closed slot is in particular formed between two teeth which each include pole shoes at their free end, which close the slot at least in part.

Alternatively, the slots can be fully closed. The term “fully closed slot” denotes slots which are not open radially toward the air gap.

In one embodiment, at least one slot, or even each slot, can be continuously closed on the side of the air gap by a material bridge made from the same piece as the teeth defining the slot. All the slots can be closed on the side of the air gap by material bridges closing the slots. The material bridges may be made from the same piece as the teeth defining the slot. The stator mass in such a case has no cut between the teeth and the material bridges closing the slots, and the slots are then continuously closed on the side of the air gap by the material bridges made from the same piece as the teeth defining the slot.

Furthermore, the slots can also be closed on the side opposite the air gap by a yoke that is attached to or made from the same piece as the teeth. The slots are then not open radially outward. The stator mass may have no cut between the teeth and the yoke.

In one embodiment, each of the slots has a continuously closed contour. “Continuously closed” means that the slots have a continuous closed contour when they are observed in cross-section, taken perpendicular to the rotational axis of the machine. It is possible to go all the way around the slot without encountering a cut in the stator mass.

The stator may include coils arranged in a distributed manner in the slots, in particular having electrical conductors arranged in a row in the slots. “Distributed” means that at least one of the coils passes successively into two non-adjacent slots.

The electrical conductors may not be arranged in the slots in bulk, but rather in an ordered manner. They are stacked in the slots in a non-random manner, being for example arranged in rows of aligned electrical conductors. The stack of electrical conductors is for example a stack according to a hexagonal network in the case of electrical conductors of circular cross-section.

The stator may include electrical conductors housed in the slots. At least some, or even a majority, of the electrical conductors may be in the form of U or I pins. The pin can be U-shaped (“U-pin”) or straight, being I-shaped (“I-pin”).

The electrical conductors can thus form a distributed winding. The winding may not be concentrated or wound on a tooth.

In an alternative embodiment, the stator has a concentrated winding. The stator may include teeth and coils arranged on the teeth. The stator can thus be wound on teeth, in other words with non-distributed winding.

The teeth of the stator may include pole shoes. In one variant, the teeth of the stator are devoid of pole shoes.

The stator may include an outer carcass surrounding the yoke.

The teeth of the stator can be produced with a stack of magnetic laminations, each covered with an insulating varnish, in order to limit the losses from induced currents.

According to another of its aspects, a method for cooling a rotating electrical machine as described above is provided, wherein the rotor is supplied with cooling fluid, which is oriented by the guide device towards the winding heads of the stator.

Preferably, the cooling fluid may not be pressurized.

The cooling fluid can only flow through the effect of gravity and by the centrifugal force of the rotor. Advantageously, it may not be necessary to put the cooling fluid under pressure.

### BRIEF DESCRIPTION OF THE DRAWINGS

The following provides description of non-limiting examples of implementation of the described methods and devices, and on examining the appended drawing, wherein:

FIG. 1 is a longitudinal sectional view of a rotary electrical machine.

FIG. 2 is a perspective view of the guiding parts of the machine of FIG. 1.

FIG. 3 is a schematic and partial view in perspective of the machine of FIG. 1.

FIG. 4 is a view similar to FIG. 3 of an alternative embodiment.

FIG. 5 is a view similar to FIG. 1 of an alternative embodiment.

FIG. 6 is a view similar to FIG. 2 of the alternative embodiment of FIG. 5.

FIG. 7 is a view similar to FIG. 1 of an alternative embodiment.

FIG. 8 is a view similar to FIG. 2 of the alternative embodiment of FIG. 7.

FIG. 9 is a longitudinal sectional view in detail of an alternative embodiment.

FIG. 10 is a view similar to FIG. 2 of the alternative embodiment of FIG. 9.

FIG. 11 is a view similar to FIG. 9 of an alternative embodiment.

FIG. 12 is a view similar to FIG. 9 of an alternative embodiment.

FIG. 13 is a view similar to FIG. 1 of an alternative embodiment.

FIG. 14 is a view similar to FIG. 2 of the alternative embodiment of FIG. 13.

FIG. 15 is a view similar to FIG. 3 of an alternative embodiment.

FIG. 16 is a front view of a guiding part according to another embodiment.

FIG. 17 is a profile view of the guiding part of FIG. 16.

FIG. 18 is a view analogous to FIG. 3 of an alternative embodiment.

### DETAILED DESCRIPTION

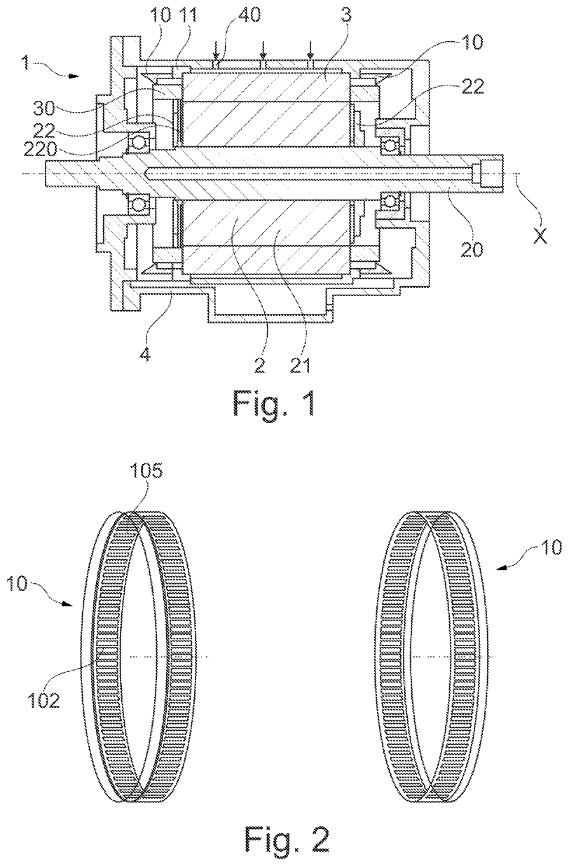

FIGS. 1 to 3 show an example of an electrical machine 1. The electrical machine 1 comprises a rotor 2 and a wound stator 3 which extend along a longitudinal axis X. The rotor 2 comprises a shaft 20 and a rotor mass 21. The wound stator 3 has winding heads 30. The rotor 2 and the stator 3 are arranged in a casing 4.

The electrical machine 1 is supplied with cooling fluid by the rotor 2. For example, the cooling fluid may come from axial channels positioned either in the laminations of the rotor, or between the laminations of the rotor and the shaft. Alternatively, the cooling fluid may come from a channel provided in the shaft. The electrical machine also comprises two end plates 22 arranged at the two axial ends of the rotor mass 21. Each end plate 22 comprises one or several radial cooling fluid distribution channels 220. These radial channels 220 are supplied with cooling fluid by the rotor. The cooling fluid is ejected from the end plates 22 to the winding heads 30 by the centrifugal force when the electrical machine is in operation.

The electrical machine is also supplied with cooling fluid from the casing 4. The cooling fluid flows through openings 40 to the winding heads 30 to cool them.

In this embodiment, the electrical machine 1 comprises two guide devices 10 arranged at the two axial ends of the electrical machine and a flange 11. The two guide devices 10 are symmetrical to one another relative to a plane perpendicular to the longitudinal axis X of the electrical machine. The guide devices 10 are arranged radially between the winding heads 30 and the casing 4. The flange 11 is arranged radially above the coil ends 30, at the same position on the longitudinal axis X of the machine as the end plates 22. The flange 11 in particular participates in the mechanical retention of the stator in the casing.

The guide devices 10 are arranged above the winding heads 3. The guide device 10 located on the left in FIG. 1 is in contact with the flange 11. The guide devices 10 are coaxial with the longitudinal axis X of the electrical machine.

As shown in FIG. 2, the guide devices 10 are entirely annular and comprise a cylindrical part 105.

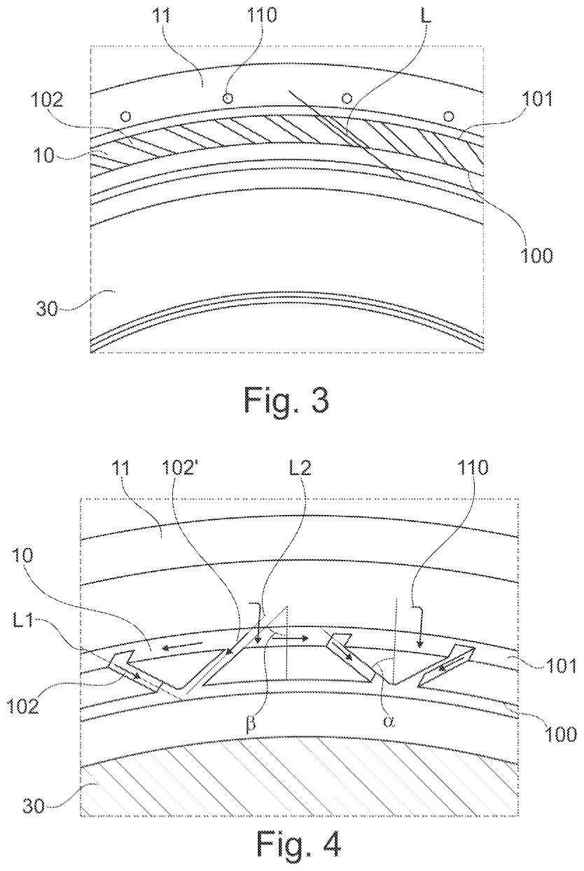

Each guide device 10 comprises an internal surface 100 and an external surface 101, visible in FIG. 3. Openings 102 are provided between the internal surface 100 and the external surface 101. The openings 102 are substantially rectangular on the inner and external surfaces. The openings 102 have a constant cross-section. The openings 102 extend along an axis parallel to the longitudinal axis X of the machine.

The openings 102 extend between the outer and inner faces along an elongation axis L. In the example shown, the elongation axes L of all the openings 102 are oriented in the same direction oblique to a plane perpendicular to the longitudinal axis X of the machine. The elongation axis L of the openings 102 is inclined relative to a plane containing the longitudinal axis X of the machine by an angle θ of the order of 25°. The distance between two adjacent openings 102 on the inner 100 and outer 101 surface of the guide device is constant. In this example, it is of the order of 4 mm.

The cooling fluid dispensed from the casing 4 flows through orifices 110 provided in the flange 11, then flows through the openings 102 of the guide device 10. Thus, the guide device 10 allows the flow of the cooling fluid from the casing, and in particular, thanks to the inclination of the openings, prevents the cooling fluid from rising. This makes it possible to concentrate a larger quantity of cooling fluid at the winding heads 30. The cooling of the electrical machine 1 is thus improved.

Another embodiment of the guide devices 10 is illustrated in FIG. 4. In this embodiment, the guide device 10 is entirely annular. It comprises an internal surface 100 and an external surface 101. Openings 102, 102′ are provided between the internal surface 100 and the external surface 101. The openings 102, 102′ have a substantially rectangular cross-section. The openings 102, 102′ extend along an axis parallel to the longitudinal axis X of the machine. One half of the openings 102 have an elongation axis L1 of a first inclination relative to a radial axis in a transverse plane of the machine. The rest of the openings 102′ have an elongation axis L2 of a second inclination, opposite the first, relative to a radial axis in a transverse plane of the machine. An opening 102 having an elongation axis L1 of a first inclination is surrounded on either side by openings 102′ having an elongation axis L2 of second inclination.

In the example shown, the openings 102, 102′ are alternately V-shaped and truncated V-shaped in the circumferential direction of the machine. The V-shaped openings are arranged in the form of a V of half-angle at the apex a of the order of 45°. The truncated V-shaped openings are arranged in the form of a truncated V of half-angle at the summit β of the order of 45°.

The cooling fluid from the casing 4 flows through holes 110 provided in the flange 11 and then through the openings 102, 102′. The distance between two adjacent openings 102, 102′ on the external surface of the guide device is not constant. The distance between two adjacent openings 102, 102′ on the internal surface of the guide device is of the order of 0 mm, when two adjacent openings join at the tip of a V, or of the order of 4 mm.

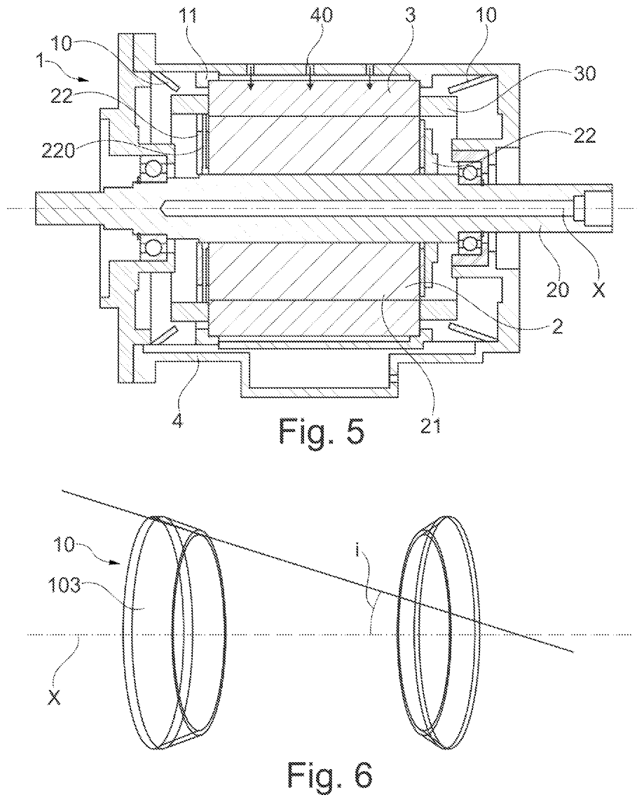

In the embodiment of FIGS. 5 and 6, the guide devices 10 comprise a frustoconical part 103 coaxial with the longitudinal axis X of the machine. The frustoconical part 103 is arranged longitudinally beyond the winding heads 30, that is to say that it protrudes to the right or to the left past the winding heads 30. This frustoconical part 103 is oriented towards the winding heads and is not in contact with the winding heads. The frustoconical part 103 of the guide device flares as the winding heads 30 are moved longitudinally towards the outside of the machine.

Thus, the cooling fluid that is coming from the rotor 2 flows along the wall of the casing 3 and then along one of the guide devices 10 in order to be redirected towards the winding heads 30.

Furthermore, the cooling fluid coming from the casing 4 falls onto the winding heads 30. The exterior surface of the frustoconical portion 103 has an angle of inclination i of the order of 30° relative to the longitudinal axis X of the machine in a plane containing the longitudinal axis X of the machine.

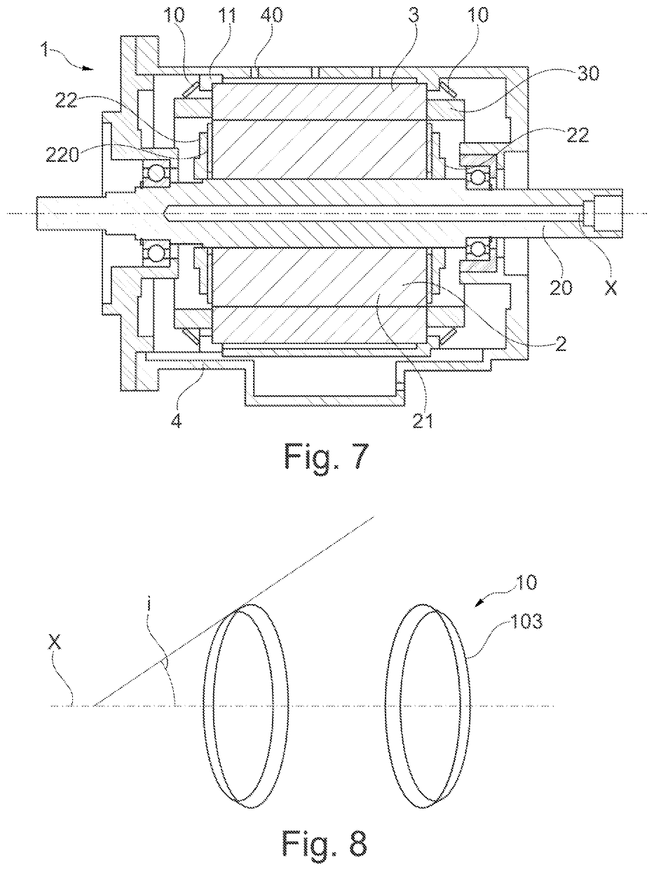

In the embodiment of FIGS. 7 and 8, the guide devices 10 comprise a frustoconical part 103 coaxial with the longitudinal axis X of the machine. The frustoconical part 103 is arranged above the winding heads 30. This frustoconical part 103 is oriented towards the winding heads and is not in contact with the winding heads. It approaches the longitudinal axis X of the machine when moving longitudinally away from the winding heads towards the outside of the machine. The exterior surface of the frustoconical part has an inclination of the order of 30° relative to the longitudinal axis X of the machine in a plane containing the longitudinal axis X of the machine.

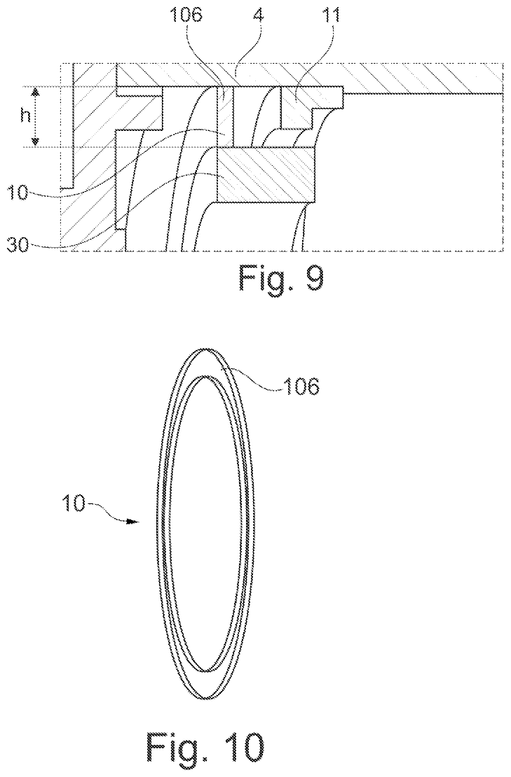

In the embodiments of FIGS. 9 to 12, the guide devices 10 comprise a vertical wall 106 that extends from the internal wall of the casing 4 to the winding heads 30. This vertical wall 106 makes it possible to break the flow of cooling fluid that flows along the internal wall of the casing 4 and that is coming from the rotor and/or from the casing. Thus, the flow of cooling fluid is oriented towards the winding heads 30.

In the embodiments of FIGS. 9 and 12, the vertical wall 106 is in contact with the winding heads 30.

In the embodiment of FIG. 9, the height h of the vertical wall 106 in the radial direction is equal to the gap between the winding heads and the internal wall of the casing.

In the embodiment of FIG. 12, the height h of the vertical wall 106 in the radial direction is greater than the gap between the winding heads and the internal wall of the casing.

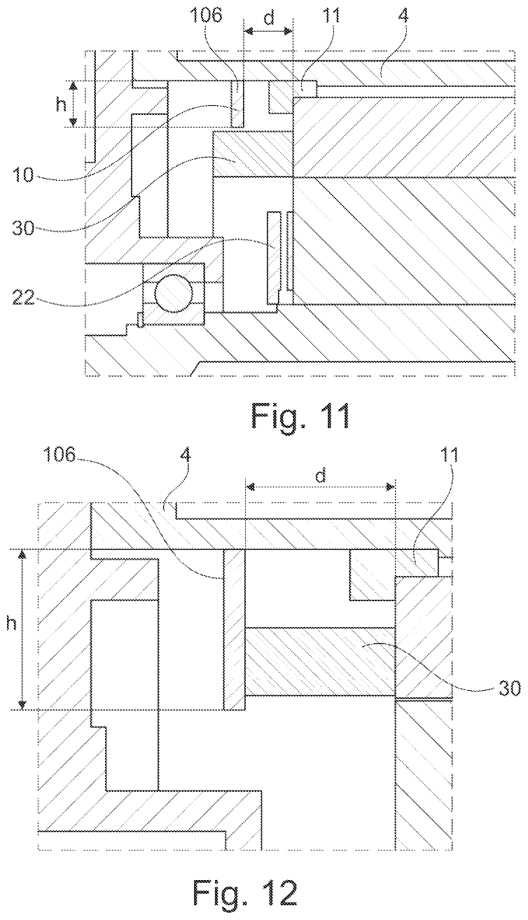

In the embodiment of FIG. 11, the vertical wall 106 of the guide device 10 is not in contact with the winding heads. This arrangement allows better axial flow of the cooling fluid.

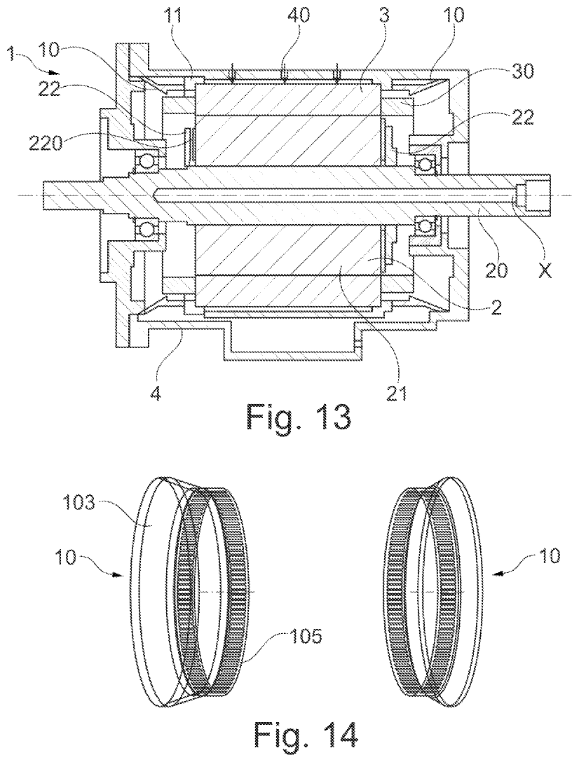

In the embodiment of FIGS. 13 and 14, the guide devices 10 comprise a frustoconical part 103 and a cylindrical part 105. The frustoconical part 103 is similar to the one described with reference to FIGS. 5 and 6. The cylindrical part 105 is similar to the one described with reference to FIGS. 1 and 2.

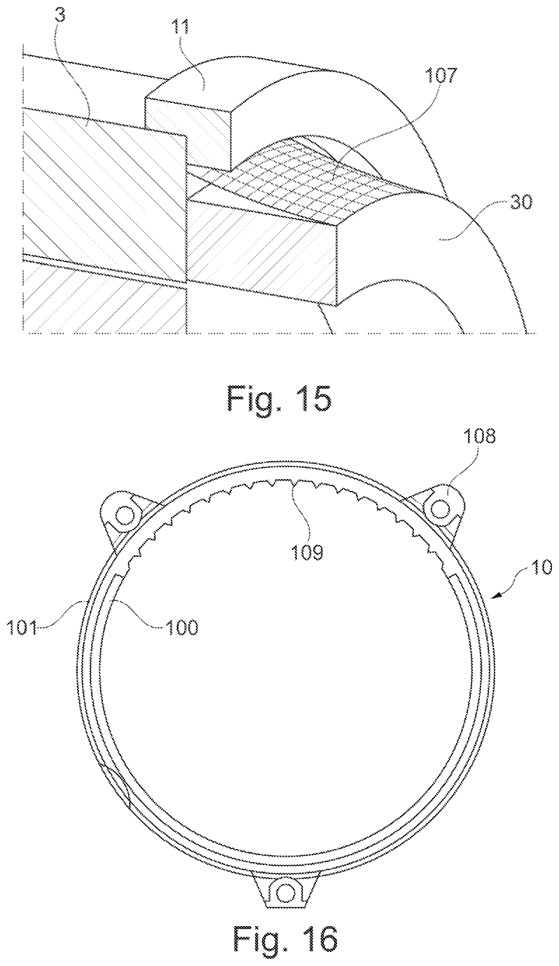

An alternative embodiment is shown in FIG. 15. In this alternative, the guide device 10 comprises a wire mesh part 107, for example a flexible wire mesh part. The wire mesh part 107 is in contact with the winding heads 30 of the stator. The wire mesh part 107 makes it possible to attract by capillarity the cooling fluid coming from the rotor and/or coming from the casing 4.

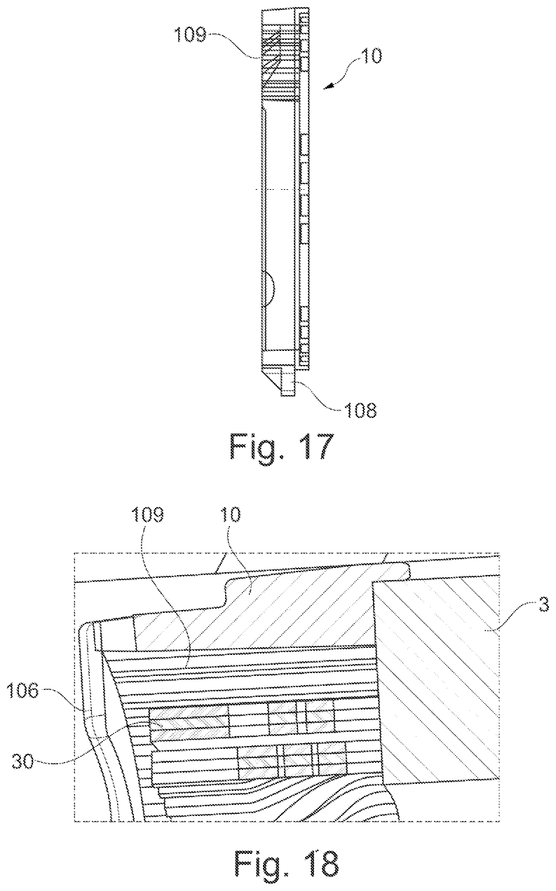

In the embodiments of FIGS. 16 to 18, the guide device 10 comprises attachment means 108. The guide device 10 then also acts as a flange and participates in the mechanical holding of the electrical machine. The guide device 10 comprises, on its internal surface 100, ribs 109 extending parallel to the longitudinal axis X of the electrical machine. These ribs 109 make it possible to break the flow of cooling fluid coming from the rotor in order to reorient it towards the winding heads 30. The part of the internal surface 100 of the guide device that comprises ribs 109 extends over substantially 120° around the longitudinal axis X of the electrical machine 1.

In the embodiment of FIG. 18, the guide device 10 further comprises a vertical wall 106.

Of course, the methods and devices are not limited to the exemplary embodiments that have just been described. It is possible to combine differently the elements that have just been described on a guide device. For example, a guide device may comprise a cylindrical part with openings and a vertical wall.

Furthermore, the rotor associated with the stator described can be wound, squirrel cage or permanent magnets, or even with variable reluctance.

1. A rotary electrical machine extending along a longitudinal axis X, having a rotor and a wound stator having winding heads, the rotor and the stator being arranged in a casing having an internal wall, the rotor having at least one channel for distribution of a cooling fluid, the machine having at least one guide device arranged radially between the winding heads of the stator and the internal wall of the casing,
the guide device being configured to orient the cooling fluid ejected from the rotor, particularly by centrifugal force, to the winding heads of the stator.

2. The electrical machine according to claim 1, further comprising a supply of cooling fluid through the casing, the cooling fluid coming from the casing being able to be oriented towards the winding heads, by the guide device.

3. The electrical machine according to claim 1, wherein the guide device is at least partially annular, in particular entirely annular, when seen in cross section, the guide device being able to be coaxial with a shaft of the rotor.

4. The electrical machine according to claim 3, wherein the guide device comprises an internal surface and an external surface and openings provided between the external surface and the internal surface and/or reliefs on the inner face.

5. The electrical machine according to claim 4, wherein the reliefs are ribs.

6. The electrical machine according to claim 4, wherein the openings each extends along an elongation axis L which is oblique in a plane perpendicular to the longitudinal axis X of the machine.

7. The electrical machine according to claim 6, wherein the elongation axes L of the openings is oriented in the same oblique direction in a plane perpendicular to the longitudinal axis X of the machine.

8. The electrical machine according to claim 6, wherein at least two openings comprise axes of elongation L oriented in two different directions that are oblique in a plane perpendicular to the longitudinal axis X of the machine.

9. The electrical machine according to claim 4, wherein the openings have on the internal surface and/or on the external surface a surface area of between 5 and 350 mm².

10. The electrical machine according to claim 1, wherein the guide device comprises a frustoconical part coaxial with the longitudinal axis X of the machine and oriented towards the winding heads.

11. The electrical machine according to claim 10, wherein the exterior surface of the frustoconical portion has an inclination of between 5 and 85°, relative to the longitudinal axis X of the machine in a plane containing the longitudinal axis X of the machine.

12. The electrical machine according to claim 1, wherein the guide device comprises at least one vertical wall extending from the internal wall of the casing to the winding heads.

13. The electrical machine according to claim 12, wherein the vertical wall is in contact with the winding heads of the stator.

14. The electrical machine according to claim 13, wherein the vertical wall is arranged radially at a non-zero distance from the winding heads of the stator.

15. The electrical machine according to claim 1, wherein the guide device comprises at least one wire mesh part.

16. The machine according to claim 15, wherein the wire mesh part has an inclination of between 0° and 45°, relative to the longitudinal axis X of the machine in a plane containing the longitudinal axis X of the machine.

17. The machine according to claim 1, wherein the guide device comprises means of attachment to the casing.

18. A method for cooling a rotating electrical machine according to claim 1, wherein the rotor is supplied with cooling fluid, which is oriented by the guide device towards the winding heads of the stator.

19. The cooling method according to claim 18, wherein the cooling fluid is not pressurized.

20. The electrical machine according to claim 5, wherein the reliefs are ribs extending parallel to the longitudinal axis X of the machine.
